(19) United States
(12) Patent Application Publication
(10) Pub. No.: US 2025/0316910 A1
(43) Pub. Date: Oct. 9, 2025

(54) REFLECTING DEVICE AND CONTROL METHOD THEREOF

(71) Applicant: Japan Display Inc., Tokyo (JP)

(72) Inventors: Daijiro TAKANO, Tokyo (JP); Masayuki IKARI, Tokyo (JP)

(73) Assignee: Japan Display Inc., Tokyo (JP)

(21) Appl. No.: 19/243,985

(22) Filed: Jun. 20, 2025

Related U.S. Application Data
(63) Continuation of application No. PCT/JP2023/042565, filed on Nov. 28, 2023.

(30) Foreign Application Priority Data
Dec. 22, 2022 (JP) 2022-205319

(51) Int. Cl. H01Q 15/14

(52) U.S. Cl. CPC H01Q 15/148

(57) ABSTRACT

A reflecting device includes a first intelligent reflecting surface; and a second intelligent reflecting surface, each of the first intelligent reflecting surface and the second intelligent reflecting surface includes a reflecting surface arranged with a plurality of intelligent reflecting elements, and a mounting surface adjacent to the reflecting surface, and arranged with a circuit that drives the plurality of intelligent reflecting elements. A second side of the first intelligent reflecting surface opposite to a first side arranged with the mounting surface is arranged to overlap the mounting surface of the second intelligent reflecting surface. The normal direction of the reflecting surface of the first intelligent reflecting surface is inclined with respect to the normal direction of a virtual straight line connecting the first side of the first intelligent reflecting surface and the first side of the second intelligent reflecting surface.

### CROSS-REFERENCE TO RELATED APPLICATIONS

This application is a Continuation of International Patent Application No. PCT/JP2023/042565, filed on Nov. 28, 2023, which claims the benefit of priority to Japanese Patent Application No. 2022-205319, filed on Dec. 22, 2022, the entire contents of each are incorporated herein by reference.

### FIELD

An embodiment of the present invention relates to a reflecting device having an intelligent reflecting surface using a liquid crystal material and a control method thereof.

### BACKGROUND

A phased array antenna device has a property that, when a high-frequency signal is applied to a part or all of a plurality of antenna elements, the radiation directivity of the antenna can be controlled while the direction of the antenna is fixed in one direction by controlling the amplitudes and phases of the respective high-frequency signals. A phased array antenna device using a phase shifter using a phenomenon in which a dielectric constant of a liquid crystal is changed by an applied voltage is disclosed as an example (see Japanese laid-open patent publication No. H11-103201).

On the other hand, a liquid crystal metasurface reflecting plate in which a reflection direction of a radio wave is changed by utilizing the dielectric anisotropy of a liquid crystal is known. For example, Japanese laid-open patent publication No. 2019-530387 discloses a metasurface that adjusts the reflection phase by changing the orientation of molecules of the liquid crystal in an intelligent reflecting element by applying a voltage to the intelligent reflecting element including the liquid crystal, and controls the resonance frequency of the corresponding intelligent reflecting element.

### SUMMARY

A reflecting device according to one embodiment of the present invention includes a first intelligent reflecting surface; and a second intelligent reflecting surface; each of the first intelligent reflecting surface and the second intelligent reflecting surface includes a reflecting surface arranged with a plurality of intelligent reflecting elements; and a mounting surface adjacent to the reflecting surface, and arranged with a circuit that drives the plurality of intelligent reflecting elements. A second side of the first intelligent reflecting surface opposite to a first side arranged with the mounting surface is arranged to overlap the mounting surface of the second intelligent reflecting surface. The normal direction of the reflecting surface of the first intelligent reflecting surface is inclined with respect to the normal direction of a virtual straight line connecting the first side of the first intelligent reflecting surface and the first side of the second intelligent reflecting surface.

A control method for a reflecting device according to one embodiment of the present invention includes the first pitch of the plurality of intelligent reflecting elements is P, the inclination of the normal direction of the reflecting surface of the first intelligent reflecting surface with respect to the normal direction of a virtual straight line is θ, and the amount of change in phase αn of the reflected waves of the first intelligent reflecting element and the n-th intelligent reflecting element is 2×((n−1)P·sin θ).

### BRIEF DESCRIPTION OF DRAWINGS

FIG. 1A is a plan view showing a configuration of an intelligent reflecting surface according to an embodiment of the present invention.

FIG. 1B is an enlarged plan view showing a configuration of an intelligent reflecting surface according to an embodiment of the present invention.

FIG. 2 is a side view showing a configuration of a reflecting device according to an embodiment of the present invention.

FIG. 3A is a plan view showing configuration of a reflecting device according to an embodiment of the present invention.

FIG. 3B is an enlarged plan view showing a configuration of a reflecting device according to an embodiment of the present invention.

FIG. 4 is a cross-sectional end view showing an example of a thin film transistor of an intelligent reflecting surface according to a modification of the present invention.

FIG. 5 is an enlarged side view showing a configuration of an intelligent reflecting surface according to an embodiment of the present invention.

FIG. 6 is a side view showing a configuration of a reflecting device according to an embodiment of the present invention.

### DESCRIPTION OF EMBODIMENTS

It is desirable that an intelligent reflecting surface be large in order to increase the reflection strength of a radio wave. However, in terms of manufacturing, transportation, and installation, the larger the size, the higher the cost, which is undesirable. Therefore, it is effective for use in tiling in which a plurality of intelligent reflecting surfaces is installed in combination to increase the size at the time of use.

However, a frame region of the intelligent reflecting surface in which an intelligent reflecting element is not arranged and a gap between the intelligent reflecting surface and the intelligent reflecting surface are ineffective regions. Further, the size of the ineffective region varies depending on the size of the frame and the gap between intelligent reflecting surfaces. Therefore, in the case where the intelligent reflecting surfaces are combined to form one large reflecting device, there is a problem that the pitch of the intelligent reflecting element does not become constant in a plane, and the in-plane uniformity of a reflecting surface is impaired.

Hereinafter, embodiments of the present invention will be described with reference to the drawings and the like. However, the present invention can be implemented in many different aspects, and is not to be construed as being limited to the description of the embodiments exemplified below. The width, thickness, shape, and the like of each part may be schematically represented in comparison with the actual embodiments in order to clarify the description, but the drawings are merely examples and do not limit the interpretation of the present invention. In the present specification and the drawings, elements similar to those described above with respect to the above-described figures are denoted by the same reference signs (or reference signs added with a, b, and the like) and detailed description thereof may be omitted as appropriate. Furthermore, the terms “first” and “second” with respect to the respective elements are convenient signs used to distinguish the respective elements, and do not have any further meaning unless otherwise specified.

In the present specification, a member or region is “on (or under)” another member or region, including, without limitation, the case where it is directly above (or below) another member or region, but also the case where it is above (or below) another member or region, i.e., the case where another component is included between above (or below) another member or region. Further, in the following description, unless otherwise specified, in a cross-sectional view, the upper side is referred to as “upper” or “above” with respect to the front position of the drawing, the surface viewed from “upper” or “above” is referred to as “upper surface” or “upper surface side”, and the opposite side is referred to as “lower”, “below”, “lower surface” or “lower surface side”.

### First Embodiment

### Configuration of Intelligent Reflecting Surface

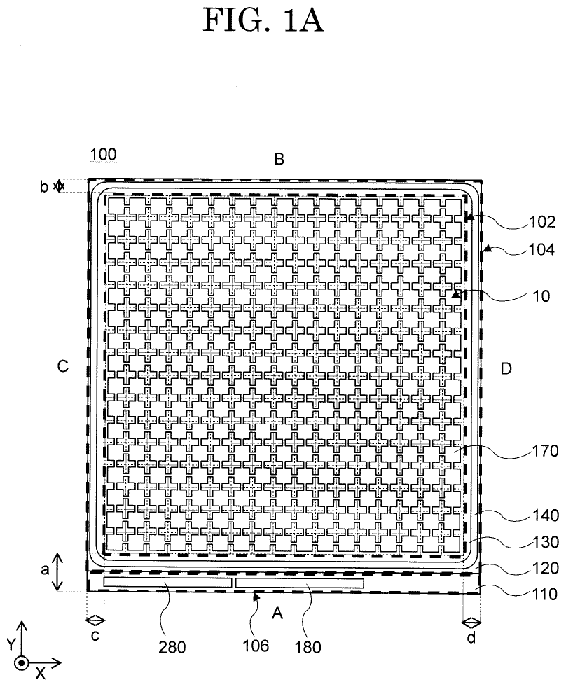

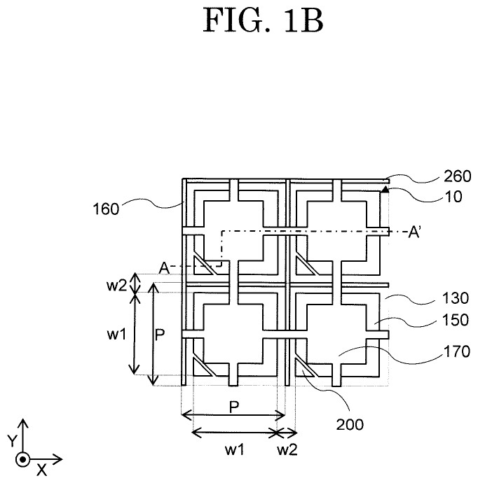

FIG. 1A shows a plan view of an intelligent reflecting surface according to an embodiment of the present invention. FIG. 1B shows an enlarged plan view of a reflecting element of an intelligent reflecting surface according to an embodiment of the present invention. An intelligent reflecting surface 100 is provided with a reflective region (reflecting surface) 102 for reflecting radio waves and a peripheral region 104 surrounding the reflective region 102 on a first surface of an array substrate 110. In the reflective region 102, which is rectangular in a plan view, a plurality of reflecting elements (intelligent reflecting elements) 10 is spaced apart at the same interval w2 as the adjacent reflecting element 10, and is arranged in an array in a first direction (direction X) parallel to the first side A of the array substrate 110 at the same period (pitch) P and in a second direction (direction Y) orthogonal to the first direction.

The reflective device 10 includes a first electrode 150, a liquid crystal layer 130, and a second electrode 170. A plurality of first electrodes 150 is formed on the first surface of the array substrate 110. A plurality of second electrodes 170 is formed on a first surface of a counter substrate 120. The first electrode 150 and the second electrode 170 are spaced apart from each other in a third direction (direction Z) orthogonal to the first direction (direction X) and the second direction (direction Y), and are arranged to face each other. The liquid crystal layer 130 is arranged in a region between the first electrode 150 and the second electrode 170. The liquid crystal layer 130 and the second electrode 170 are commonly arranged in the plurality of reflecting elements 10. The plurality of second electrodes 170 is a patch electrode in which adjacent electrodes are connected by wiring. One first electrode 150 is arranged for each of the plurality of reflecting elements 10, and is arranged so that adjacent first electrodes have a gap. The first electrode 150 is a liquid crystal control electrode that defines one unit of the reflecting element 10.

The intelligent reflecting surface 100 is a device that scatters a radio wave incident on the incident surface in a predetermined direction. The counter substrate 120 is arranged on the incident surface side, and the array substrate 110 is arranged on the rear side of the incident surface. That is, the second electrode 170 is arranged on the incident surface, and the first electrode 150 is arranged on the back surface of the second electrode 170 with the liquid crystal layer 130 interposed therebetween.

In the present embodiment, the plurality of first electrodes 150 is shown as squares having the same width w1 in the first direction (direction X) and the second direction (direction Y), respectively. However, the present invention is not limited to this, and the plurality of first electrodes 150 may be symmetrical in the first direction (direction X) and the second direction (direction Y), and may be, for example, polygonal or circular.

The plurality of first electrodes 150 is spaced apart from each other by the same interval w2 in the first direction (X-axis direction). The plurality of first electrodes 150 is spaced apart from each other by the same interval w2 in the second direction (Y-axis direction) orthogonal to the first direction. The interval w2 of the plurality of first electrodes 150 aligned in the first direction (X-axis direction) and the interval w2 of the plurality of first electrodes 150 aligned in the second direction (Y-axis direction) are substantially the same.

The plurality of first electrodes 150 is arranged in an array at the same period (pitch) P in the first direction (X-axis direction). The plurality of first electrodes 150 is arranged in an array at the same period (pitch) P in the second direction (Y-axis direction) orthogonal to the first direction. The period (pitch) P of the plurality of first electrodes 150 aligned in the first direction (X-axis direction) and the period (pitch) P of the plurality of first electrodes 150 aligned in the second direction (Y-axis direction) are substantially the same. The period (pitch) P of the first electrode 150 is the sum of the width w1 of the first electrode 150 and the interval w2 of the first electrode 150.

The period (pitch) P at which the reflecting element 10 is arranged is preferably in a range of ⅓ or more and ½ or less of the wavelength of the radio wave so as to maximize the reflected power. For example, assuming a 28 GHz band used in Japanese 5G, since the wavelength is 10.7 mm, the period (pitch) P in which the reflecting element 10 is arranged is preferably 3 mm or more and 6 mm or less.

In the reflective region 102, the plurality of first electrodes 150 arranged along the second direction (Y-axis direction) is electrically connected by a bias signal line 160. The bias signal line 160 is drawn from the first end of the reflective region 102 to the peripheral region 104 and electrically connected via a wiring to a drive circuit 180 that drives the reflecting element 10. The drive circuit 180 outputs a bias signal to the bias signal line 160. The drive circuit 180 is mounted on a mounting portion 106 arranged on the first side A (a part of the peripheral region 104) of the array substrate 110. The counter substrate 120 exposes wirings (not shown) and the drive circuit 180 on the array substrate 110 at the mounting portion 106. The mounting portion 106 extends along the first end of the reflective region 102 and the first side A of the array substrate 110 in the first direction (direction X). A flexible printed substrate is further connected to the drive circuit 180 via a terminal (not shown).

In the reflective region 102, the plurality of first electrodes 150 arranged along the first direction (X-axis direction) is electrically connected by a select signal line 260. The select signal line 260 is drawn from the first end of the reflective region 102 to the peripheral region 104 and electrically connected via a wiring to a drive circuit 280 that drives the reflecting element 10. The drive circuit 280 outputs a selection signal to the select signal line 260. The drive circuit 280 is mounted on the mounting portion 106 arranged on the first side A (a part of the peripheral region 104) of the array substrate 110. The counter substrate 120 exposes wirings (not shown) and the drive circuit 280 on the array substrate 110 at the mounting portion 106. A flexible printed substrate is further connected to the drive circuit 280 via a terminal (not shown). The drive circuit 180 and the drive circuit 280 may be integrated and arranged.

In the reflective region 102, the first electrodes 150 are each connected to a thin film transistor (TFT) 200. The thin film transistor 200 used as a switching element has a gate connected to the select signal line 260, one input and output terminal connected to the bias signal line 160, and the other input and output terminal connected to the first electrode 150. The switching operation (on/off state) of the thin film transistor 200 is controlled by the selection signal of the select signal line 260, and the bias signal (bias voltage) is input from the bias signal line 160. The bias signal is individually input to the first electrode 150 by the thin film transistor 200. That is, the bias signal is individually input to the first electrode 150 arranged in a matrix by the thin film transistors 200.

In the reflective region 102, the liquid crystal layer 130 is filled between the plurality of first electrodes 150 and the second electrodes 170. In the peripheral region 104, the liquid crystal layer 130 is surrounded and sealed by a seal 140.

The first surface of the array substrate 110 includes a first side A on which the mounting portion 106 is arranged, a second side B opposite to the first side A, a third side C connecting the first side A and the second side B, and a fourth side D opposite to the third side C. In the present embodiment, a distance a from the first side A on which the mounting portion 106 is arranged to the plurality of reflecting elements 10 adjacent to the first side A is larger than a distance b from the second side B to the plurality of reflecting elements 10 adjacent to the second side B, is larger than a distance c from the third side C to the plurality of reflecting elements 10 adjacent to the third side C, and is larger than a distance d from the fourth side D to the plurality of reflecting elements 10 adjacent to the fourth side D.

In the present embodiment, the sum of the distance c from the third side C to the plurality of reflecting elements 10 adjacent to the third side C and the distance d from the fourth side D to the plurality of reflecting elements 10 adjacent to the fourth side D may be the sum of the integer multiple of the period (pitch) P in which the plurality of reflecting elements 10 is arranged and the interval w2 of the adjacent reflecting elements 10. In other words, the sum of a width c of the peripheral region arranged on the third side C and a width d of the peripheral region arranged on the fourth side D may satisfy IW1+(I+1)W2 (I is an integer of 0 or more) when the width of the reflecting element 10 is W1 and the interval of the reflecting elements 10 is W2. In this case, the width c of the peripheral region indicates the distance between the third side C in the first direction (X-axis direction) and the end of the reflecting element 10 of the reflective region 102, and the width d of the peripheral region indicates the distance between the fourth side D in the first direction (X-axis direction) and the end of the reflecting element 10 of the reflective region 102.

In the present embodiment, twice the distance c from the third side C to the plurality of reflecting elements 10 adjacent to the third side C may be the sum of the integer multiple of the period (pitch) P in which the plurality of reflecting elements 10 is arranged and the interval w2 of the adjacent reflecting elements 10. In other words, twice the width c of the peripheral region arranged on the third side C may satisfy mW1+(m+1)W2 (m is an integer of 0 or more) when the width of the reflecting element 10 is W1 and the interval of the reflecting elements 10 is W2.

In the present embodiment, twice the distance d from the fourth side D to the plurality of reflecting elements 10 adjacent to the fourth side D may be the sum of the integer multiple of the period (pitch) P in which the plurality of reflecting elements 10 is arranged and the interval w2 of the adjacent reflecting elements 10. In other words, twice the width d of the peripheral region arranged on the fourth side D may satisfy nW1+(n+1)W2 (n is an integer of 0 or more) when the width of the reflecting element 10 is W1 and the interval of the reflecting elements 10 is W2. The width c of the peripheral region arranged on the third side C may be different from or the same as the distance d from the fourth side D to the plurality of reflecting elements 10 adjacent to the fourth side D.

Since the intelligent reflecting surface according to the present embodiment has the above-described configuration, it is possible to make the pitch of the reflecting elements in the first direction (X-axis direction) constant in the plane when the plurality of intelligent reflecting surfaces is combined.

### Configuration of Intelligent Reflecting Surface

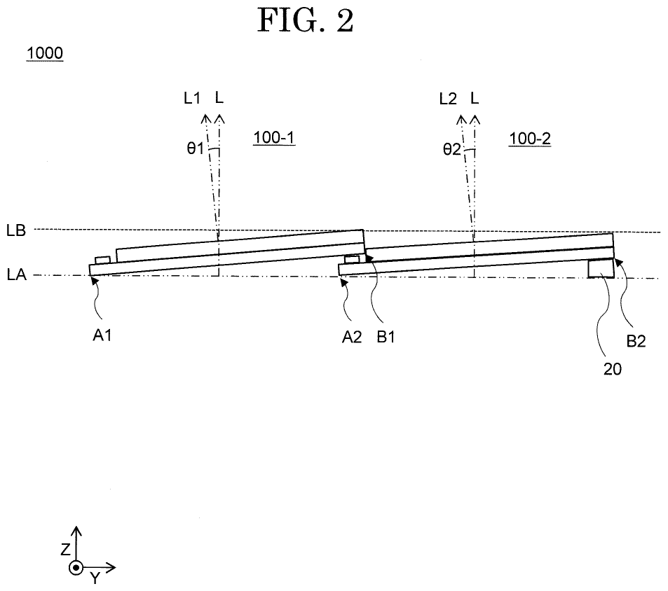

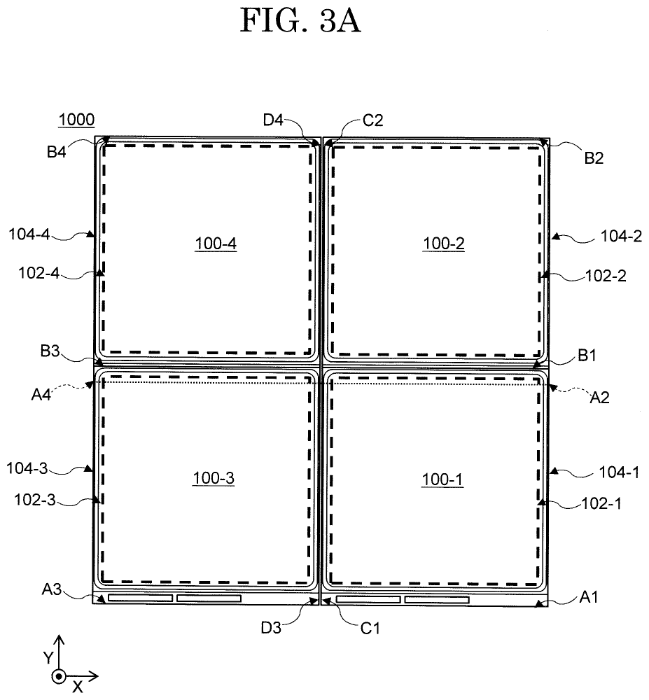

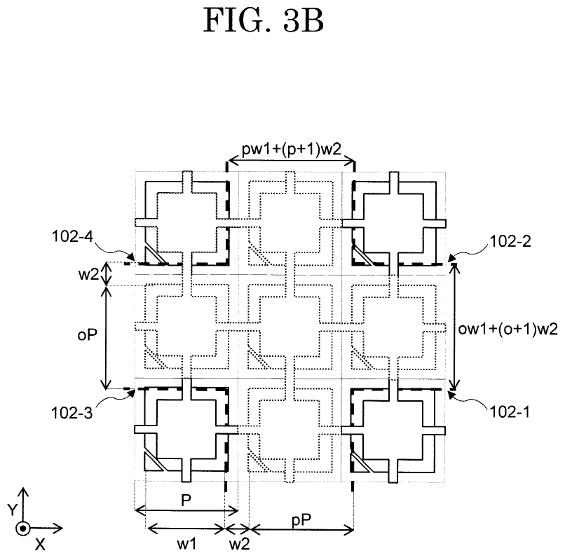

FIG. 2 is a side view of the reflecting device according to an embodiment of the present invention. FIG. 3A shows a plan view of the reflecting device according to an embodiment of the present invention. FIG. 3B shows an enlarged plan view of connection parts of the respective intelligent reflecting surfaces in the reflecting device according to an embodiment of the present invention. Further, in FIG. 3B, the reflecting element 10 indicated by the dotted line is not actually arranged, but is shown as a virtual reflecting element so that the pitch of the combination can be easily understood. A reflecting device 1000 includes an intelligent reflecting surface 100-1, an intelligent reflecting surface 100-2, an intelligent reflecting surface 100-3, and an intelligent reflecting surface 100-4 (when the intelligent reflecting surfaces 100-1, 100-2, 100-3, and 100-4 are not distinguished, the intelligent reflecting surface 100 is used). Each of the intelligent reflecting surfaces 100-1, 100-2, 100-3, and 100-4 includes reflective regions 102-1, 102-2, 102-3, and 102-4 which reflect a radio wave and peripheral regions 104-1, 104-2, 104-3, and 104-4 surrounding the reflective regions 102-1, 102-2, 102-3, and 102-4 (when the reflective regions 102-1, 102-2, 102-3, and 102-4 are not distinguished, the reflective region 102 is used, and when the peripheral regions 104-1, 104-2, 104-3, and 104-4 are not distinguished, the peripheral region 104 is used). The intelligent reflecting surfaces 100-1, 100-2, 100-3, and 100-4 are arranged so that the reflective regions 102-1, 102-2, 102-3, and 102-4 face the same side. In the reflective region 102, the plurality of reflecting elements 10 is spaced apart at the same interval w2 from the adjacent reflecting element 10, and is arranged in an array in the first direction (direction X) along the first side A of the array substrate 110 at the same period (pitch) P and in the second direction (direction Y) orthogonal to the first direction.

The first surface of the array substrate 110 included in the intelligent reflecting surface 100-1 includes a first side A1 on which a mounting portion 106-1 is arranged, a second side B1 opposite to the first side A1, a third side C1 connecting the first side A1 and the second side B1, and a fourth side D1 opposite to the third side C1. The first surface of the array substrate 110 included in the intelligent reflecting surface 100-2 includes a first side A2 on which a mounting portion 106-2 is arranged, a second side B2 opposite to the first side A2, a third side C2 connecting the first side A2 and the second side B2, and a fourth side D2 opposite to the third side C2. The first surface of the array substrate 110 included in the intelligent reflecting surface 100-3 includes a first side A3 on which a mounting portion 106-3 is arranged, a second side B3 opposite to the first side A3, a third side C3 connecting the first side A3 and the second side B3, and a fourth side D3 opposite to the third side C3. The first surface of the array substrate 110 included in the intelligent reflecting surface 100-4 includes a first side A4 on which a mounting portion 106-4 is arranged, a second side B4 opposite to the first side A4, a third side C4 connecting the first side A4 and the second side B4, and a fourth side D4 opposite to the third side C4.

In the present embodiment, the second side B1 of the intelligent reflecting surface 100-1 and the first side A2 of the intelligent reflecting surface 100-2 are arranged so as to overlap each other. The second side B1 of the intelligent reflecting surface 100-1 is arranged so as to overlap the mounting portion 106-2 arranged on the first side A2 of the intelligent reflecting surface 100-2. By arranging the second side B1 of the intelligent reflecting surface 100-1 so as to overlap the mounting portion 106-2 of the intelligent reflecting surface 100-2, the ineffective region in which the reflecting element 10 is not arranged can be reduced.

A spacer 20 is arranged below the second side B2 of the intelligent reflecting surface 100-2. The height of the spacer 20 in a normal direction L2 of the reflective region 102-2 may be substantially the same as the height of the mounting portion 106-2 in the normal direction L2 of the reflective region 102-2. Since the spacer 20 is arranged below the second side B2 of the intelligent reflecting surface 100-2, the reflective region 102-1 of the intelligent reflecting surface 100-1 and the reflective region 102-2 of the intelligent reflecting surface 100-2 are arranged substantially parallel to each other. Since the spacer 20 is arranged below the second side B2 of the intelligent reflecting surface 100-2, the reflection position of the first reflecting element 10-1 arranged on the second side B1 of the reflective region 102-1 of the intelligent reflecting surface 100-1 and the reflection position of the first reflecting element 10-1 arranged on the second side B2 of the reflective region 102-2 of the intelligent reflecting surface 100-2 are positioned at substantially the same height. A virtual straight line LB (dotted line) connecting the reflection position of the first reflecting element 10-1 arranged on the second side B1 side of the reflective region 102-1 of the intelligent reflecting surface 100-1 and the reflection position of the first reflecting element 10-1 arranged on the second side B2 side of the reflective region 102-2 of the intelligent reflecting surface 100-2 is substantially parallel to a virtual straight line LA (two-dot chain line) connecting the first side A1 of the intelligent reflecting surface 100-1 and the first side A2 of the intelligent reflecting surface 100-2.

A normal direction L1 of the reflective region 102-1 of the intelligent reflecting surface 100-1 is inclined with respect to the normal direction L of the virtual straight line LA connecting the first side A1 of the intelligent reflecting surface 100-1 and the first side A2 of the intelligent reflecting surface 100-2.

The normal direction L2 of the reflective region 102-2 of the intelligent reflecting surface 100-2 is inclined with respect to the normal direction L of the virtual straight line LA. An angle θ1 of the reflective region 102-1 of the intelligent reflecting surface 100-1 with respect to the normal direction L of the virtual straight line LA and an angle θ2 of the reflective region 102-2 of the intelligent reflecting surface 100-2 with respect to the normal direction L of the virtual straight line LA are preferably substantially the same angle (when the angle θ1 and the angle θ2 are not distinguished from each other, the angle θ2 is defined as an angle θ). Since the reflective region 102-1 of the intelligent reflecting surface 100-1 and the reflective region 102-2 of the intelligent reflecting surface 100-2 are arranged substantially in parallel, it is possible to easily adjust the position at the time of installation, and the directional control of the radio wave can be simplified.

The second side B1 of the intelligent reflecting surface 100-1 and the first side A2 of the intelligent reflecting surface 100-2 are arranged substantially parallel to each other. The distance in the second direction (Y-axis direction) between the reflecting element 10 arranged adjacent to the second side B1 of the intelligent reflecting surface 100-1 and the reflecting element 10 arranged adjacent to the first side A2 of the intelligent reflecting surface 100-2 is the sum of the integer multiple of the period (pitch) P in which the plurality of reflecting elements 10 is arranged and the interval w2 of the adjacent reflecting elements 10. In other words, the distance between the reflective region 102-1 of the intelligent reflecting surface 100-1 and the reflective region 102-2 of the intelligent reflecting surface 100-2 satisfies oW1+(o+1)W2 (o is an integer of 0 or more) when the width of the reflecting elements 10 is W1 and the interval of the reflecting elements 10 is W2. In this case, the distance between the reflective region 102-1 and the reflective region 102-2 indicates a distance when viewed in a plan view from the normal direction of the reflective region 102-1 and the reflective region 102-2, and does not include a distance in a step direction where the intelligent reflecting surface 100-1 and the intelligent reflecting surface 100-2 overlap.

Since the reflecting device according to the present embodiment has the above-described configuration, the pitch of the reflecting elements in the second direction (Y-axis direction) can be made constant in the plane when the plurality of intelligent reflecting surfaces is combined.

In the present embodiment, the third side C1 of the intelligent reflecting surface 100-1 and the third side C2 of the intelligent reflecting surface 100-2 are aligned on the same line in the second direction (direction Y). However, the present invention is not limited to this, and the third side C1 of the intelligent reflecting surface 100-1 and the third side C2 of the intelligent reflecting surface 100-2 may be shifted in the first direction (direction X).

In the present embodiment, the second side B3 of the intelligent reflecting surface 100-3 and the first side A4 of the intelligent reflecting surface 100-4 are arranged so as to overlap each other. The second side B3 of the intelligent reflecting surface 100-3 is arranged so as to overlap the mounting portion 106-4 arranged on the first side A4 of the intelligent reflecting surface 100-4. By arranging the second side B3 of the intelligent reflecting surface 100-3 so as to overlap the mounting portion 106-4 of the intelligent reflecting surface 100-4, the ineffective region in which the reflecting element 10 is not arranged can be reduced.

Since the arrangement of the intelligent reflecting surface 100-3 and the intelligent reflecting surface 100-4 is the same as the arrangement of the intelligent reflecting surface 100-1 and the intelligent reflecting surface 100-2, descriptions therefore will be omitted here. The virtual straight line LA connecting the first side A3 of the intelligent reflecting surface 100-3 and the first side A4 of the intelligent reflecting surface 100-4 is arranged so as to be parallel to the virtual straight line LA connecting the first side A1 of the intelligent reflecting surface 100-1 and the first side A2 of the intelligent reflecting surface 100-2. Therefore, the reflective region 102-1 of the intelligent reflecting surface 100-1, the reflective region 102-2 of the intelligent reflecting surface 100-2, the reflective region 102-3 of the intelligent reflecting surface 100-3, and the reflective region 102-4 of the intelligent reflecting surface 100-4 are arranged substantially in parallel. Since the reflective region 102-1 of the intelligent reflecting surface 100-1, the reflective region 102-2 of the intelligent reflecting surface 100-2, the reflective region 102-3 of the intelligent reflecting surface 100-3, and the reflective region 102-4 of the intelligent reflecting surface 100-4 are arranged substantially in parallel, it is possible to easily adjust the position at the time of installation, and the directional control of the radio wave can be simplified.

In the present embodiment, the third side C1 of the intelligent reflecting surface 100-1 and the fourth side D3 of the intelligent reflecting surface 100-3 are arranged adjacent to each other. The third side C1 of the intelligent reflecting surface 100-1 and the fourth side D3 of the intelligent reflecting surface 100-3 are arranged substantially parallel to each other.

A distance in the first direction (X-axis direction) between the reflecting element 10 arranged adjacent to the third side C1 of the intelligent reflecting surface 100-1 and the reflecting element 10 arranged adjacent to the fourth side D3 of the intelligent reflecting surface 100-3 is the sum of the integer multiple of the period (pitch) P in which the plurality of reflecting elements 10 is arranged and the interval w2 of the adjacent reflecting elements 10. In other words, a distance between the reflective region 102-1 of the intelligent reflecting surface 100-1 and the reflective region 102-3 of the intelligent reflecting surface 100-3 satisfies pW1+(p+1)W2 (p is an integer of 0 or more) when the width of the reflecting element 10 is W1 and the interval of the reflecting elements 10 is W2. In this case, the distance between the reflective region 102-1 and the reflective region 102-3 indicates the sum of the distance between the third side C1 and the reflective region 102-1, the distance between the third side C1 and the fourth side D3 in the first direction (X-axis direction), and the distance between the fourth side D3 and the reflective region 102-3 in the first direction (X-axis direction) when viewed in a plan view from the normal direction of the reflective region 102-1 and the reflective region 102-3.

The distance between the reflective region 102-1 of the intelligent reflecting surface 100-1 and the reflective region 102-3 of the intelligent reflecting surface 100-3 is preferably substantially the same as the distance between the reflective region 102-1 of the intelligent reflecting surface 100-1 and the reflective region 102-2 of the intelligent reflecting surface 100-2. Therefore, the integer n and the integer m are preferably the same.

The third side C1 of the intelligent reflecting surface 100-1 and the fourth side D3 of the intelligent reflecting surface 100-3 are preferably arranged in contact with each other, and the distance between the third side C1 and the fourth side D3 in the first direction (X-axis direction) is preferably 0. However, the present invention is not limited to this, and may be separated as long as the distance between the reflective region 102-1 of the intelligent reflecting surface 100-1 and the reflective region 102-3 of the intelligent reflecting surface 100-3 satisfies the above-described range.

Since the reflecting device according to the present embodiment has the above-described configuration, when the plurality of intelligent reflecting surfaces is combined, the pitch of the reflecting elements can be made constant in the plane.

In the present embodiment, the second side B1 of the intelligent reflecting surface 100-1 and the second side B3 of the intelligent reflecting surface 100-3 are aligned on the same line in the first direction (direction X). However, the present invention is not limited to this, and the second side B1 of the intelligent reflecting surface 100-1 and the second side B3 of the intelligent reflecting surface 100-3 may be shifted in the second direction (direction Y).

In the present embodiment, the third side C2 of the intelligent reflecting surface 100-2 and the fourth side D4 of the intelligent reflecting surface 100-4 are arranged adjacent to each other. The third side C2 of the intelligent reflecting surface 100-2 and the fourth side D4 of the intelligent reflecting surface 100-4 are arranged substantially parallel to each other. Since the arrangement of the intelligent reflecting surface 100-2 and the intelligent reflecting surface 100-4 is the same as the arrangement of the intelligent reflecting surface 100-1 and the intelligent reflecting surface 100-3, descriptions thereof will be omitted here.

FIGS. 3A and 3B show a configuration in which four intelligent reflecting surfaces 100 are combined. However, the present invention is not limited to this, and an additional intelligent reflecting surface 100 may be combined in the lower left-right direction based on the intelligent reflecting surfaces 100-2 and 100-4 on which the spacer 20 is arranged. The second side B of the additional intelligent reflecting surface 100 may be arranged so as to overlap the mounting portions 106-1 and 106-3 of the intelligent reflecting surfaces 100-1 and 100-3, the fourth side D of the additional intelligent reflecting surface 100 may be arranged adjacent to the third sides C3 and C4 of the intelligent reflecting surfaces 100-3 and 100-4, and the third side C of the additional intelligent reflecting surface 100 may be arranged adjacent to the fourth sides D1 and D2 of the intelligent reflecting surfaces 100-1 and 100-2.

In the reflecting device according to the present embodiment, the ineffective region in which the intelligent reflecting elements are not arranged in the plane in which the plurality of intelligent reflecting surfaces is combined can be reduced, and the pitch of the reflecting elements can be made constant. With the above-described configuration, in the reflecting device according to the present embodiment, it is possible to easily adjust the position at the time of installation, and the directional control of the radio wave can be simplified.

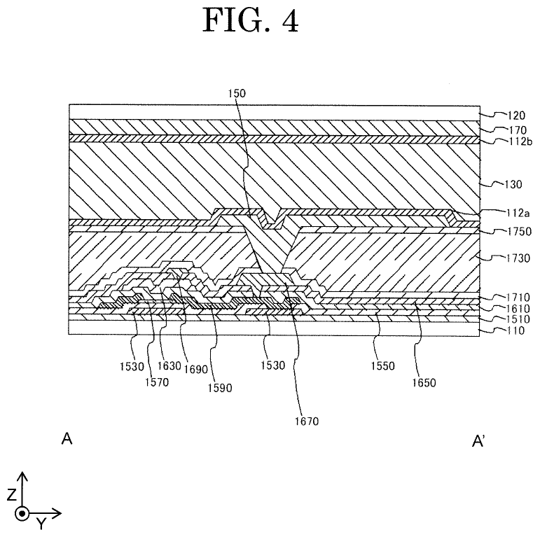

In the intelligent reflecting surface 100, the first electrode 150 is connected to the bias signal line 160 and the select signal line 260 via the thin film transistor 200 shown in FIG. 4. FIG. 4 is a cross-sectional view showing an example of the thin film transistor 200. For example, the thin film transistor 200 has a structure in which an undercoat layer 1510, a gate electrode 1530, a bottom-gate insulating film 1550, an oxide semiconductor layer 1570, a first connection wiring layer 1590, a top-gate insulating film 1610, a bottom-gate electrode 1630, a passivation film 1650, a second connection wiring layer 1670, a signal line 1690, and an insulating film 1710 are sequentially stacked on the array substrate 110. An overcoat layer 1730, an insulating film 1750, the first electrode 150, a first alignment film 112a, the liquid crystal layer 130, a second alignment film 112b, the second electrode 170, and the counter substrate 120 are sequentially stacked on the thin film transistor 200.

For example, the undercoat layer 1510 may be made of a silicon oxide film. For example, the bottom-gate insulating film 1550 may be formed of a stacked structure of a silicon nitride film and a silicon oxide film. For example, the gate electrode 1530 may be made of molybdenum, tungsten, or an alloy thereof. For example, the top-gate insulating film 1610 may be made of a silicon oxide film. In addition, for example, the first connection wiring layer 1590 and the second connection wiring layer 1670 may be formed of a stacked structure of Ti/Al/Ti or a stacked structure of Mo/Al/Mo. For example, the passivation film 1650 may be made of a silicon nitride film. For example, the insulating film 1710 may be made of a silicon oxide film or a silicon nitride film. For example, the first electrode 150 may be formed of a stacked structure of Ti/Al/Ti or a stacked structure of Mo/Al/Mo. For example, the second electrode 170 may be made of molybdenum, tungsten, or an alloy thereof.

Further, in FIG. 4, the thin film transistor 200 is shown as a dual-gate TFT using an oxide semiconductor, but amorphous silicon may be used, or low-temperature polysilicon (LTPS) may be used. In addition, although an example of vertical electric field driving is shown in FIG. 4, horizontal electric field driving may be used.

The reflecting device 1000 further includes a controller (not shown) that controls the potential difference between the first electrode 150 and the second electrode 170 via the thin film transistor 200. The controller controls a voltage applied to each first electrode 150, thereby controlling the potential difference between each first electrode 150 and second electrode 170, and drives each liquid crystal layer 130 to change the dielectric constant depending on the orientation state of liquid crystal molecules. By independently changing the dielectric constant of each liquid crystal layer 130, the phase of the radio wave reflected by each reflecting element 10 changes, and consequently, the traveling direction of the irradiated radio wave changes. With this mechanism, the intelligent reflecting surface 100 can reflect the radio wave at a reflection angle different from an incident angle.

### Method for Controlling Intelligent Reflecting Surface

In the present embodiment, the normal direction of the reflective region 102 of the intelligent reflecting surface 100 is inclined at the angle θ in the second direction (Y-axis direction) with respect to the normal direction L of the virtual straight line LA. Therefore, it is necessary for the plurality of reflecting elements 10 arranged in the second direction (Y-axis direction) to correct the reflection angle by the inclination angle θ of the intelligent reflecting surface 100. The reflection angle is determined by the phase change amount of a reflected wave, and the phase change amount of the reflected wave can be controlled by controlling the potential difference between the first electrode 150 and the second electrode 170 by the controller. In the intelligent reflecting surface 100, each first electrode 150 is connected to the select signal line 260 via the thin film transistor 200 shown in FIG. 4, and is individually controlled.

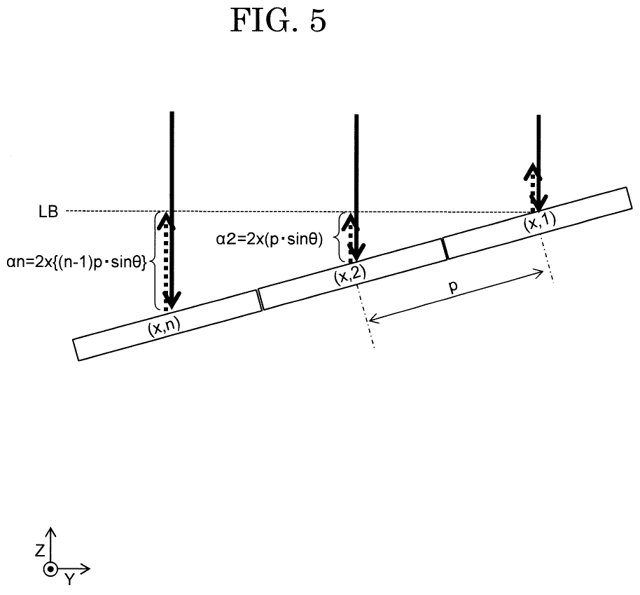

As shown in FIG. 5, the plurality of reflecting elements 10 arranged in the second direction (Y-axis direction) has different phases of the reflected waves. In the plurality of reflecting elements 10 arranged in the second direction (Y-axis direction), the phase of the reflected wave from the second side B side toward the first side A side of the array substrate 110 is delayed. The plurality of reflecting elements 10 of the intelligent reflecting surface 100 includes a first reflecting element 10-1, a second reflecting element 10-2 adjacent to the first side A side of the first reflecting element 10-1, and an n-th reflecting element 10-n arranged on the first side A side of the first reflecting element 10-1 with n−2 reflecting elements 10 interposed therebetween. In this case, assuming that the period (pitch) P of the plurality of reflecting elements 10 aligned in the second direction (Y-axis direction) and the inclination in the normal direction of the reflective region 102 of the intelligent reflecting surface 100 with respect to the normal direction L of the virtual straight line LA are θ, a phase change amount α2 of the reflected wave of the second reflecting element 10-2 with respect to the reflection position LB of the first reflecting element 10-1 satisfies 2×(p·sin θ), and a phase change amount αn of the reflected wave of the n-th reflecting element 10-n with respect to the reflection position LB of the first reflecting element 10-1 satisfies 2×((n−1)p·sin θ).

Since the phase of the n-th reflecting element 10-n is delayed by 2×((n−1)p·sin θ) with respect to the first reflecting element 10-1, a voltage that advances the phase by that amount is applied to the n-th reflecting element 10-n. When the voltage applied to the first reflecting element 10-1 is Vpp and the wavelength of the radio wave is λ, the voltage V2 applied to the second reflecting element 10-2 satisfies Vpp·α2/λ, and the voltage Vn applied to the n-th reflecting element 10-n satisfies Vpp·αn/λ. Since the plurality of reflecting elements 10 arranged in the second direction (Y-axis direction) satisfies the above-described condition, the phases of the reflected waves of the plurality of reflecting elements 10 of the intelligent reflecting surface 100 can be aligned with the reflection position LB of the first reflecting element 10-1. The voltage Vn applied to the n-th reflective device 10-n is preferably adjusted as appropriate based on the gamma property of the liquid crystal.

Since the reflective regions 102 of the plurality of intelligent reflecting surfaces 100 are arranged substantially parallel to each other in the reflecting device 1000, the phases of the reflected waves of the plurality of intelligent reflecting surfaces 100 of the reflecting device 1000 can be aligned by performing the same correction on the respective reflecting elements 10 in all the intelligent reflecting surfaces 100.

Further, the intelligent reflecting surface 100 has a reflection axis parallel to the first direction (X-axis direction) and a reflection axis parallel to the second direction (Y-axis direction). In the intelligent reflecting surface 100, the first electrode 150 is connected to the bias signal line 160 and the select signal line 260 via the thin film transistor 200 shown in FIG. 4, and is individually controlled. Therefore, the intelligent reflecting surface 100 can control the reflection angle in a rotation direction with a reflection axis parallel to the first direction (X-axis direction) and a reflection axis parallel to the second direction (Y-axis direction) as axes. Therefore, by combining these elements, the reflection angle in all directions ahead with respect to the reflecting device 1000 can be controlled.

### Second Embodiment

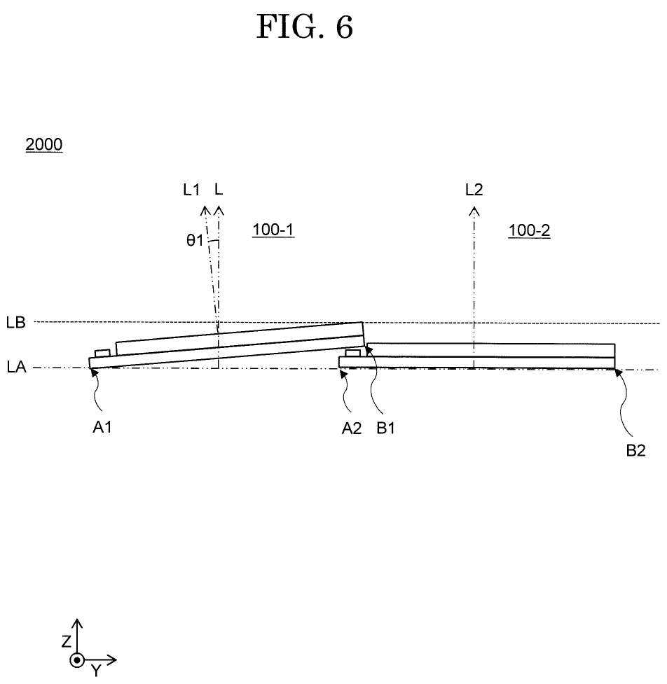

Since a reflecting device 2000 according to the second embodiment is the same as the reflecting device 1000 according to the first embodiment except that the spacer 20 is not arranged below the second sides B2 and B4 of the intelligent reflecting surfaces 100-2 and 100-4 as shown in FIG. 6, repeated explanation thereof is omitted.

In the present embodiment, the normal direction L2 of the reflective region 102-2 of the intelligent reflecting surface 100-2 is substantially parallel to the normal direction L of the virtual straight line LA connecting the first side A1 of the intelligent reflecting surface 100-1 and the first side A2 of the intelligent reflecting surface 100-2. The normal direction of the reflective region 102-4 of the intelligent reflecting surface 100-4 (not shown) is substantially parallel to the normal direction L of the virtual straight line LA connecting the first side A1 of the intelligent reflecting surface 100-1 and the first side A2 of the intelligent reflecting surface 100-2. Therefore, in the intelligent reflecting surfaces 100-2 and 100-4, it is not necessary to correct the reflection angles with respect to the plurality of reflecting elements 10 arranged in the second direction (Y-axis direction).

On the other hand, the reflection position LB of the first reflecting element 10-1 arranged on the second side B1 side of the reflective region 102-1 of the intelligent reflecting surface 100-1 is different from the reflection position of the first reflecting element 10-1 arranged on the second side B2 side of the reflective region 102-2 of the intelligent reflecting surface 100-2. The reflection position of the n-th reflecting element 10-n arranged on the first side A1 side of the reflective region 102-1 of the intelligent reflecting surface 100-1 and the reflection position of the first reflecting element 10-1 arranged on the second side B2 side of the reflective region 102-2 of the intelligent reflecting surface 100-2 are positioned at substantially the same height. Therefore, in the intelligent reflecting surfaces 100-2 and 100-4, it is necessary to correct the reflection positions with respect to the plurality of reflecting elements 10 arranged in the second direction (Y-axis direction). In this case, assuming that the period (pitch) P of the plurality of reflecting elements 10 aligned in the second direction (Y-axis direction) and the inclination in the normal direction of the reflection region 102-1 of the intelligent reflecting surface 100-1 are θ1, the change amount of the reflection position of the reflecting element 10 arranged in the reflective region 102-2 of the intelligent reflecting surface 100-2 with respect to the reflection position LB of the first reflecting element 10-1 of the reflective region 102-1 of the intelligent reflecting surface 100-1 is substantially the same as the phase change amount αn=2×(LA)p·sin θ of the reflected wave of the n-th reflecting element 10-n with reference to the reflection position LB of the first reflecting element 10-1 of the reflective region 102-1 of the intelligent reflecting surface 100-1.

Since the phase of the reflecting element 10 arranged in the reflective region 102-2 of the intelligent reflecting surface 100-2 is delayed by 2×((n−1)p·sin θ) with respect to the first reflecting element 10-1 arranged on the second side B1 side of the reflective region 102-1 of the intelligent reflecting surface 100-1, a voltage that advances the phase by that amount is applied to the reflecting element 10 arranged in the reflective region 102-2 of the intelligent reflecting surface 100-2. When the voltage applied to the first reflecting element 10-1 arranged on the second side B1 side of the reflective region 102-1 of the intelligent reflecting surface 100-1 is Vpp and the wavelength of the radio wave is λ, the voltage applied to the reflecting element 10 arranged in the reflective region 102-2 of the intelligent reflecting surface 100-2 satisfies Vpp·αn/λ. Since the plurality of reflecting elements 10 arranged in the second direction (Y-axis direction) of the reflective region 102-2 of the intelligent reflecting surface 100-2 satisfies the above-described condition, the phases of the reflected waves of the plurality of reflecting elements 10 of the intelligent reflecting surface 100-2 can be aligned with the reflection position LB of the first reflecting element 10-1 of the reflective region 102-1 of the intelligent reflecting surface 100-1.

Since the reflective regions 102 of the plurality of intelligent reflecting surfaces 100 other than the intelligent reflecting surfaces 100-2 and 100-4 on which the spacer 20 is not arranged in the reflecting device 2000 are arranged substantially parallel to each other, the phases of the reflected waves of the plurality of intelligent reflecting surfaces 100 of the reflecting device 2000 can be aligned by performing the same correction on the respective reflecting elements 10 in the intelligent reflecting surfaces 100.

What is claimed is:

1. A reflecting device comprising:
a first intelligent reflecting surface; and
a second intelligent reflecting surface;
each of the first intelligent reflecting surface and the second intelligent reflecting surface comprising:
a reflecting surface arranged with a plurality of intelligent reflecting elements; and
a mounting surface adjacent to the reflecting surface, and arranged with a circuit that drives the plurality of intelligent reflecting elements;
wherein
a second side of the first intelligent reflecting surface opposite to a first side arranged with the mounting surface is arranged to overlap the mounting surface of the second intelligent reflecting surface, and
the normal direction of the reflecting surface of the first intelligent reflecting surface is inclined with respect to the normal direction of a virtual straight line connecting the first side of the first intelligent reflecting surface and the first side of the second intelligent reflecting surface.

2. The reflecting device according to claim 1, wherein
the reflecting surface of the first intelligent reflecting surface and the reflecting surface of the second intelligent reflecting surface are parallel to each other.

3. The reflecting device according to claim 2, wherein
the plurality of intelligent reflecting elements are spaced apart from adjacent intelligent reflecting elements by a first interval, and are arranged at a first pitch in a first direction parallel to the first side and in a second direction perpendicular to the first direction, and the distance between the reflecting surface of the first intelligent reflecting surface and the reflecting surface of the second intelligent reflecting surface is the sum of an integer multiple of the first pitch and the first interval.

4. The reflecting device according to claim 3, further comprising
a third intelligent reflecting surface arranged adjacent to a third side connecting the first side and the second side of the first intelligent reflecting surface and including the reflecting surface;
wherein
the distance between the reflecting surface of the first intelligent reflecting surface and the reflecting surface of the third intelligent reflecting surface is the sum of an integer multiple of the first pitch and the first interval.

5. The reflecting device according to claim 4, wherein
the distance between the reflecting surface of the first intelligent reflecting surface and the reflecting surface of the second intelligent reflecting surface is the same as the distance between the reflecting surface of the first intelligent reflecting surface and the reflecting surface of the third intelligent reflecting surface.

6. The reflecting device according to claim 3, wherein
each of the plurality of intelligent reflecting elements include a first electrode, a second electrode, and a liquid crystal layer disposed between the first electrode and the second electrode.

7. The reflecting device according to claim 6, wherein
each of the plurality of intelligent reflecting elements include a transistor.

8. The reflecting device according to claim 3, wherein
the width of the intelligent reflecting element in the first direction is the same as the width of the intelligent reflecting element in the second direction.

9. The reflecting device according to claim 3, wherein
the width of the intelligent reflecting element is W1, the first interval is W2, and the sum of an integer multiple of the first pitch and the first interval is oW1+(o+1)W2 (o is an integer equal to or greater than 0).

10. The reflecting device according to claim 7, wherein
the plurality of intelligent reflecting elements of the first intelligent reflecting surface include a first intelligent reflecting element and an n-th intelligent reflecting element arranged on the first side of the first intelligent reflecting element with n−2 intelligent reflecting elements in between,
the first intelligent reflecting surface further includes a controller that controls the amount of change in phase of the reflected waves of the first intelligent reflecting element and the n-th intelligent reflecting element by the potential difference between the first electrode and the second electrode.

11. The reflecting device according to claim 10, wherein
the first pitch of the plurality of intelligent reflecting elements is P, the inclination of the normal direction of the reflecting surface of the first intelligent reflecting surface with respect to the normal direction of a virtual straight line is θ, and the amount of change in phase an of the reflected waves of the first intelligent reflecting element and the n-th intelligent reflecting element is 2×((n−1)P·sinθ).

12. The reflecting device according to claim 11, wherein
the applied voltage of the first intelligent reflecting element is Vpp, the wavelength of the radio wave is λ, and the applied voltage Vn of the n-th intelligent reflecting element is Vpp·αn/λ.

13. The reflecting device according to claim 12, wherein
the plurality of intelligent reflecting elements of the second intelligent reflecting surface also include a first intelligent reflecting element and an n-th intelligent reflecting element arranged on the first side of the first intelligent reflecting element with n−2 intelligent reflecting elements in between,
the applied voltage Vn of the n-th intelligent reflecting element of the second intelligent reflecting surface is also Vpp·αn/λ.
